(19) United States
(12) Patent Application Publication
(10) Pub. No.: US 2016/0321719 A1
(43) Pub. Date: Nov. 3, 2016

(54) Book Exchange Database for Mobile Applications

(71) Applicant: Nicky Gazy, Scaggsville, MD (US)

(72) Inventor: Nicky Gazy, Scaggsville, MD (US)

(21) Appl. No.: 14/700,200

(22) Filed: Apr. 30, 2015

(51) Int. Cl. G06Q 30/06; G06F 17/30; G06Q 10/08; G06Q 10/10; H04L 9/30; G06Q 50/00; G06Q 50/20; G06K 19/06; G06K 7/10; G06Q 30/02; H04L 29/06

(52) U.S. Cl. CPC G06Q 30/0609; G06Q 30/0613; G06Q 30/0226; G06Q 30/0214; G06F 17/30528; G06Q 10/0836; G06Q 10/107; H04L 63/0815; G06Q 50/01; G06Q 50/20; G06K 19/06046; G06K 7/10544; G06F 17/30259; H04L 63/0861; H04L 9/30; G06Q 2220/10

(57) ABSTRACT

In one example, our mobile application and system provide users with a way to sell/buy books to and from those around them. Users would first create an account linked to their .edu email address. Using a third party payment program, the user then links their payment information. This allows for the transfer of money safely with the security of this third party company. When a student or any other user wants to sell their book, they log into their account and can then enter their course number, book title, description of condition, and selling price. This can be automated by simply taking a picture of the ISBN or bar code, and it automatically populates the fields, allowing the student to change the price and condition. Other variations are also shown in the specification.

### BACKGROUND OF THE INVENTION

Throughout college, many students complain about the price of textbooks and the inability to sell their books conveniently, or for a fair price. Today when a college student wants to buy a textbook for his/her College course, he/she purchases the book from either their college book shop, visits one of the bookstores around her college, or purchase the textbook through Amazon. The price of these books, both new and used, are markedly inflated from the price which the retailer acquired the book, making the purchase of these books expensive and difficult for students. Usually, Amazon serves to be the cheapest option for most textbooks (but can still prove to be expensive). However, students purchasing their textbook through Amazon not only have to wait for the shipment of their textbooks, but also have to pay an additional shipping fee. Many on-campus students do not use Amazon due to the inconvenience and expense of dealing with postage and shipping.

At the end of the semester, after use of their textbooks, when college students want to sell their books, majority of the students sell their books back to their university or local bookstores for a greatly marked-down price. Very few students opt to sell it through Amazon for a better price. These students who would use Amazon then have to go to the nearest post office and ship their books (and many students complain about the hassle with this procedure). Most students end up not reselling their books at all.

Our mobile application/website/database/system serves to provide users with a quick and easy way to sell and buy books from other users around them.

### SUMMARY OF THE INVENTION

Our mobile application provides users with a way to sell/buy books to and from those around them. Users would first create an account linked to their .edu email address. Using a third party payment program such as Stripe or Dwolla (or our own system), the user then links their payment information. This allows for the transfer of money safely with the security of this third party company. When a student or any other user wants to sell their book, they log into their account and can then enter their course number, book title, description of condition, possible dates of exchange, and selling price. This can be automated by simply taking a picture of the ISBN or bar code, and it automatically populates the fields, allowing the student to change the price and condition. On screen, to the user, the app could provide the listed price of the same book on Amazon's website, and the lowest and highest price listed by other students.

For a College user with an account wishing to buy a book, they would log in and select their course. They would then be able to view listings for the book they wish to purchase, based on price, edition, condition, professor, University, course, or date of exchange. The user can also view the sellers profile and view reviews and ratings from other users who have purchased from them. The user could also be provided with the current price of that book on Amazon.

In one embodiment, once the check-out has been made, the seller will be able to view the buyer's profile and reviews, and decide to confirm or reject the purchase. If confirmation is made, the seller's book will be removed from the listing, the buyer will be provided with a confirmation code, and the payment from buyer will be held onto, until the book exchange has been confirmed. At this point, the users will be put in contact with each other. The users at their own discretion will decide on a location and time to meet and exchange the book. In another embodiment, the users could have the option of contacting each other prior to purchases, providing in-app messaging capabilities. In another embodiment, rather than a confirmation code, the confirmation of the exchange could be made by the buyer taking a picture of the book barcode on exchange. In another embodiment, the confirmation could be made by the app providing a map of the university and offering both users to agree on the date and time for meetup at a specified location. In another embodiment, an image can be sent to the seller, which the buyer would then take an image of or scan to confirm meetup and exchange.

This makes it very convenient for College students to exchange the book, while on campus or near each other. An additional feature could be an automated alert once the users are within a certain range of each other, based on GPS or Zip code or area code. On exchange, the buyer will provide the confirmation code to the seller, once they have received their book. The seller then enters this confirmation code and the payment is processed. A percentage of the payment or a flat rate will be applied by the app as a fee, for us. There may be an option to cancel the transaction, in one example.

To prevent price fixing, users will not be able to buy more than three copies of the same book at once, or another threshold limit as N number, or V value in dollars, e.g., within 24 hours, or 1 week period, or during 1 transaction.

This (mobile) app gives sellers a convenient way to sell their books for a better price than they would get at their local bookstore or College bookstore (which is what most students would do). It also provides the convenience of not having to find the nearest post office to ship their book to Amazon, something which very few students do to begin with. Also, many On-Campus students do not have cars to drive to the post office. This app also provides buyers with better book prices than they would get at the bookstore or Amazon. It also provides the option of exchanging the book at a mutually agreed location and time, making it convenient for students while on campus.

The website would give users the same access to the features made available on the app. One of the purposes of the website is to provide users who wish to use these features on a computer, rather than application, the ability to do so.

Note that it would provide a needed and improved service to College students and other users. Also, given the number of college students and number of books bought and sold each semester, charging a nominal fee on the buying/selling of each book proves to be very profitable.

This application can also be expanded to include all items, e.g., furniture, appliances, or decorative objects, not just books, which includes any items that could be bought and sold. However, maintaining specificity of the application to one item may make the users more likely to use it.

The website www.bookholders.com deals with books, but the features are very limited, and it does not cover our options mentioned below. Booksmart app is another example, which does not cover our options mentioned below.

Thus, in summary, the invention features and embodiments described here, below, have not been addressed or presented in any prior art.

### BRIEF DESCRIPTION OF THE DRAWINGS

FIG. 1 is one embodiment, as an example, for substrate for 3 layers with image encoded, for security, with 3 different focal lengths, for various lenses (3 lenses, or adjustable lenses), for 3 layers of film on the substrate.

FIG. 2 is one embodiment, as an example, for a method of user registration.

FIG. 3 is one embodiment, as an example, for a method of 3 people matching.

FIG. 4 is one embodiment, as an example, for a method of 2 people matching.

FIG. 5 is one embodiment, as an example, for a system with college course matching.

FIG. 6 is one embodiment, as an example, for a system with location matching.

FIG. 7 is one embodiment, as an example, for a system with notification/scheduling and confirmation modules.

FIG. 8 is one embodiment, as an example, for a system with verification, list management, optimization, and matching modules.

### DETAILED DESCRIPTION OF THE PREFERRED EMBODIMENTS

As mentioned above, we have provided a platform, system, and database, for exchange of books with all the conveniences, economic reasons, and technical innovations to implement that, which have not been offered before by anybody else.

In one embodiment, in our system, rather than the user receiving a confirmation code on purchase of the book and providing that confirmation code to the seller on “meet up” to allow the payment to go through, the buyer could take a picture of the book barcode when “meeting up” with the seller, to confirm exchange of the book.

In one embodiment, the bar code can be one dimensional, or 2-D, or numbers, or bars, or dots, or symbols, or name of the book as OCRed by an OCR module, or ISBN number, or ID number, or tracking number, or repository number, or inventory code, or library code, or Copyright Office number, or symbol of the book as recognized by an image recognizer module, or the like.

In another embodiment, the users could have the option of contacting each other prior to purchases, providing in-app messaging capabilities. In another embodiment, rather than a confirmation code, the confirmation of the exchange could be made by the buyer taking a picture of the book barcode on exchange. In another embodiment, the confirmation could be made by the app providing a map of the university and offering both users to agree on the date and time for meetup at a specified location. In another embodiment, an image can be sent to the seller, which the buyer would then take an image of or scan, to confirm meetup and exchange.

In one embodiment, our system for the application is user-to-user trading to cut out the store front (pictographically explained in the figures). It is a sort of honor system where everyone can only have one account and will be rated on their satisfaction rating for other users to see, to prevent people from robbing or cheating other users. (Logic being that one will not buy a book from someone who in their satisfaction ratings has been shown to lie about the condition of the book, and that one would want high ratings, so that one can continue to use the application).

In one embodiment, our system has a referral feature whereby each user can earn cash towards purchase of their next book. So, in app, there would be a “refer friends button” which would send a download link to selected friends in the user's “contacts” list. For each referee who signs up AND makes a purchase using the application, the referrer could receive $X in their account towards their next purchase, or gets a point award or other prizes or other benefits by our web site or other 3^{rd} party participants, for example, for co-marketing or revenue-sharing, to encourage peer-to-peer advertising and recommendation, for quick expansion and increase on user base, based on the current users. This works because the average price of college textbooks is high, so, e.g., the 4% received from the referee's purchase would cover the cost of that credited money.

In one embodiment, in our system, because the user's account is ultimately tied to their unique .edu email address, for verification and authenticity as a student, we could potentially also have a “log in through Facebook” option, if the user has already confirmed their .edu email address through Facebook's servers. In another embodiment, the user's account can be tied to their driver's license, which could either have the license number entered or a picture of the license could be taken, and the recognition software would record the license number.

In one embodiment, in our system, as shown in the figures, for the relationship between our back-end data sets, we are not keeping the payment data on our servers. That data will be with our payment company, but it is included on the diagram for illustrative purposes. The data will be populated by our back-end server methods that will grab the book data from external sites and place it on our servers.

In one embodiment, in our system, the “duration” in the diagram refers to the possible option we may include in the application. This would show the “exchange date range” during which the seller will be able to meet up to physically give the book to the buyer. In one embodiment, we have an expiration date, or deadline, beyond which the non-cooperating party gets a bad review or score from the other user and/or the web site.

In one embodiment, rather than the students meeting face to face, a courier (employed by the company) would pick up and deliver the books. The main entity diagram or flowchart would not be any different, however, there would be a second and separate part to the diagram from the courier's point of view (basically an application for the courier). As the main part of the application is the listing and sales of books between the users, and the courier is just an add-on (a new way to handle the movement of the books), which can be added as a separate module to the whole system described above. In another embodiment, we have a method of packages being sent to the seller, which will be either mailed back to the mobile company and subsequently mailed to the buyer, or pre-marked for direct mailing from seller to buyer.

In one embodiment, we have provided extra entity diagrams to account for in-app messaging, and diagrams to cover sales of other objects, as discussed above. In one embodiment, as shown in Appendix 1, we have our system, where at the beginning, the user makes a profile, with possible picture, name, address, and email address. Then, it links the profile to a payment account, e.g., using Paypal or other third party payment company. Then, you can specify the state, school, course prefix, course name and number, course profile, and books recommended by the course or required by the course, with viewing the lists, through some menu and choices.

In one embodiment, as shown in Appendix 1, we have in the listings: price, condition of the book as quality of the book, condition of the seller for if-then statement for requirement for the seller, exchange date range and deadlines, and satisfaction ratings by others displayed, as well as various listings, and other prices by Amazon, book store, or people, which can be sorted by all the topics above, for ease of viewing and comparison, which can be e.g. sorted based on date, price, proximity in mileage, using GPS or maps, or the like.

In one embodiment, as shown in Appendix 1, we have checkout with listings shown, with in depth reviews from others, for confidence and reliability. Then, we get a confirmation code, which is generally not-shared, with range of dates for exchange, with a reminder through the app or calendar, by one day before and on the same day, to set up the exchange, using contact info or in-app messaging. Then, we get the in-person exchange, for the confirmation code with the book, to use the confirmation code to get the money later on.

In one embodiment, as shown in Appendix 1, we have the review by the seller, with the in depth review. There is a “list my book” and “manage my listings” menus to manage the listings and offerings by the seller. In one embodiment, we have the picture of the bar code taken or the ISBN number entered, with extra info about the book available on the user-interface, GUI.

In one embodiment, as shown in Appendix 1, we have some added info, e.g., asking price, book condition, e.g., poor, fair, good, and excellent, and calendar for date range for exchange, as well as range of prices on other sites or stores, e.g., on Amazon. Once the book is purchased, the email or push notification is sent to the user, the listing is removed, and all data is updated. The user then logs in, to view the buyer's profile and accept the sale, with the agree-to-sell button shown on the display.

In one embodiment, as shown in Appendix 1, we have meet-up, with entering confirmation code, provided by buyer on exchange, with exchange date range, with reminder to both sides, a few days before and on the same day of the meet-up, to set up an in-person exchange, with contact info or in-app messaging. In one embodiment, as shown in Appendix 1, we have review the buyer interface, with checkout option at the interface.

In one embodiment, as shown in Appendix 2, we have book exchange, listing messaging platform (or Appendix 3 or 6, for transaction messaging or general platform), with entity relationship diagram, having user field, listing field, reputation field, website field, listing picture field, payment info field, transaction field, and messaging field, with all corresponding components and their IDs, as shown in Appendix 2 (or furniture exchange listing or transaction in Appendix 4 or 5).

In one embodiment, as shown in Appendix 7 flow chart, we have the sign up with course number and book title, using card account and email address. It indicates the condition of the book, and the max/min prices from other sources. It will update the available books and database. It shows the buyer's profile and reviews/past history. It gives the option to buy or not buy at this point. Now, it exchanges the contact info, e.g., tel number, as well as place and time of the meet-up, agreeable by both parties, with map and GPS guide on the app, to help find a common-agreeable/convenient place to meet. A transaction fee for the website is charged at this point.

In one embodiment, as shown in Appendix 7 flow chart, we have from the buyer's point of view, where it creates the account. Then, it selects the course, with listings, with price, edition, condition, and similar info. Then, there is a decision to purchase, with confirmation code, with ratings available, as well as other prices elsewhere. Then, there is a mutual location to meet, and exchange happens, with the confirmation code. In one embodiment, as shown in Appendix 9, we have 2 other examples of the system for the book exchange.

Example: Signing Up:

When a user first downloads and opens the app, they will be greeted with the sign-on/sign-up page. If they do not already have an account they will have the chance to sign up for one, using either their Facebook profile or an .edu email address. It is important that we be able to verify their academic status through their Facebook profile or, if using an .edu email address, a verification email sent to their university email. Once they have created a login, an account with our merchant will also be created. The merchant account will be tied to their account. They will then have to tie their own financial information to the merchant account.

User Experience:

After signing up for an account, the user will be able to enter the marketplace and either Buy or Sell text books. Appendix 8 is an example of the buyer's and seller's experiences. It also shows the backend data and services. It shows the backend servers, aggregate servers, and search/grab book metadata, from other web sites, e.g., price, author, and the like. It interacts with the merchant database, with security, such as biometrics or PKI or smart cards.

The app will be connected to our backend cloud database and server. The database will hold user profiles and listings, along with all of their messages with potentials buyers and sellers. This cloud database and server will have a semi-private facing API for our app to communicate with. It will also facilitate data intensive operations and user-profile storage, so users may log in from any device (phone, tablet, and website). We will not store any of the users' banking information, but in another embodiment, we can store that info. Instead, all of their merchant data, to include their banking or credit card information, will be stored with our third party merchant services. Their databases have bank-level security, including AES encryption, so that our users' data will be safe and secure.

We also have a proprietary service to aggregate book metadata from multiple exterior sites. The metadata includes, but not limited to, the book's title, author, page count and most importantly average price, as well as publisher, tags or flags about the content, the chapters, images, and the like, for extra info about the book, e.g., for fast search and classification, or finding some features in a book from the tags/flags. The algorithm finds the average price a book is going for, from multiple exterior sites, so our users can be competitive with their prices, which can be updated and changed from time to time, similar to stock market.

Once a buyer has decided on purchasing a book, they will be put in contact with the seller. We have an in-app messaging service to keep messaging safe without divulging personal information, such as email addresses or phone numbers, to shield such data. There is a third component to our backend servers, named the messaging service, which handles these communications using real-time messaging technologies, such as SignalR.

These servers will be maintained by reputable leaders in the technology industry, and will have geographical redundancy for maximum availability and automated backups, to keep our users' data, in case of crashes. We can also host the data and servers ourselves, in another embodiment.

In various embodiments, the exchange can be done based on the meetup on a common location, or go to the exchange location by each side, one at a time, or a fixed place for all, or a university or book store or our building, or in other various embodiments, it can be mailed to a location and exchanged there, or to the person, or to the other party directly.

In various embodiments, the certificate or proof of exchange can be a number or code or PKI on line or digital signature on file or on Internet or password or biometrics (or DNA to prove the identity or eye or face recognition or fingerprint or voice pattern or speaker recognition), or a magnetic card or smart card with proof recorded upon that, or a chip with recorded info/proof for transaction, or a card or printout with hologram or magnetic ink or included image as a proof, for visual or automatic verification by a device or sensor or camera with image recognition module, to reduce cheaters or fake certificates or proofs.

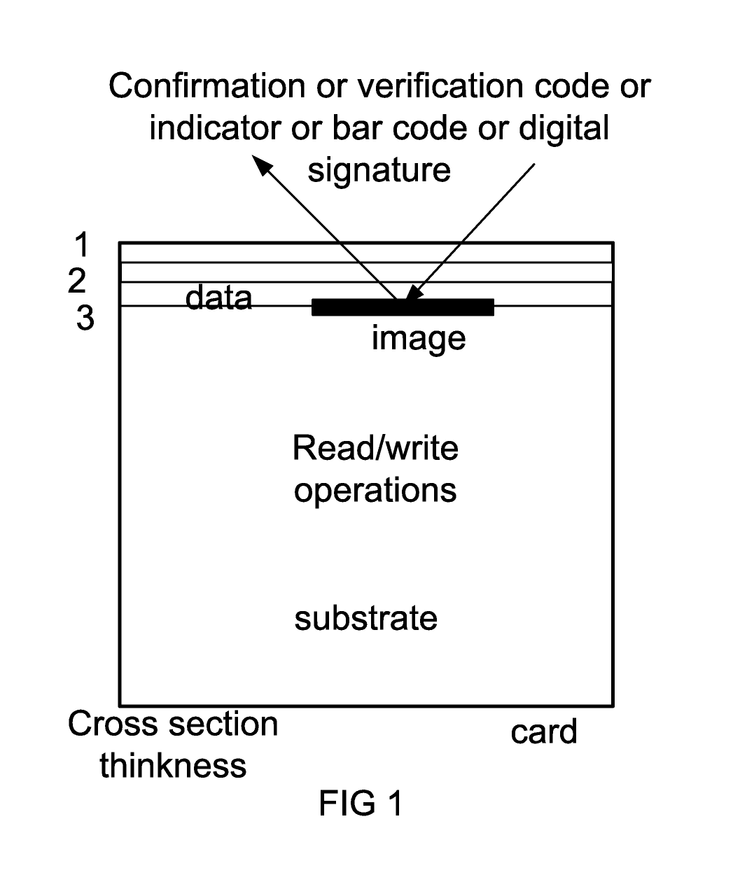

In one embodiment, we have 3 layers of images on 3 parallel horizontal planes, which are on 3 sheets of plastic (or the like), e.g., plastic wallet-size card, transparent to regular light, glued or attached together as one substrate or card or coupon or smart card or magnetic card. In this case, as shown in FIG. 1, we can have 3 different images stored on there, on 3 separate layers, at 3 different depths, with respect to the surface of the substrate, each requiring different focal length for focusing and write/read operations on the substrate. In one embodiment, the substrate has the material for recordation of image, such as camera film, in 3 layers. In one embodiment, there are pixels for electronically recording/displaying/storing an image, or transistors or LCD or flat screen for the monitor or display device, in 3 layers.

In one embodiment, the information for confirmation of transaction is done on these layers for security and confidence. In one embodiment, an image or scan of the image is recorded or scanned and transmitted to the other side or our website for verification for transfer of money or approval of purchase or exchange of the book. So, this can include a time stamp or a code signifying the time stamp for time of exchange or transfer. This also can include information unique to the parties such as biometrics or identities, to be encoded on the images on the substrate for verification and security.

In one embodiment, the information for confirmation is encoded on one image on layer number N, where N is chosen from: 1, 2, and 3, for the 3 layers. In one embodiment, the information for confirmation is encoded on multiple layers, e.g., layer 1 and 3, only. So, there are many combinations for such storage of data: (1 case for all three layers+3 two layers+3 one layer) or 7 total combinations. In one embodiment, this gives another way to secure or authenticate the confirmation or approval of the transaction or exchange.

In one embodiment, the information or image or code or message or command or bar code for confirmation is encoded or written or marked on the substrate, for example, using user's driver license number, cell phone serial number, bar code from book, actual picture of the book, biometrics, password, picture of the user, or the like.

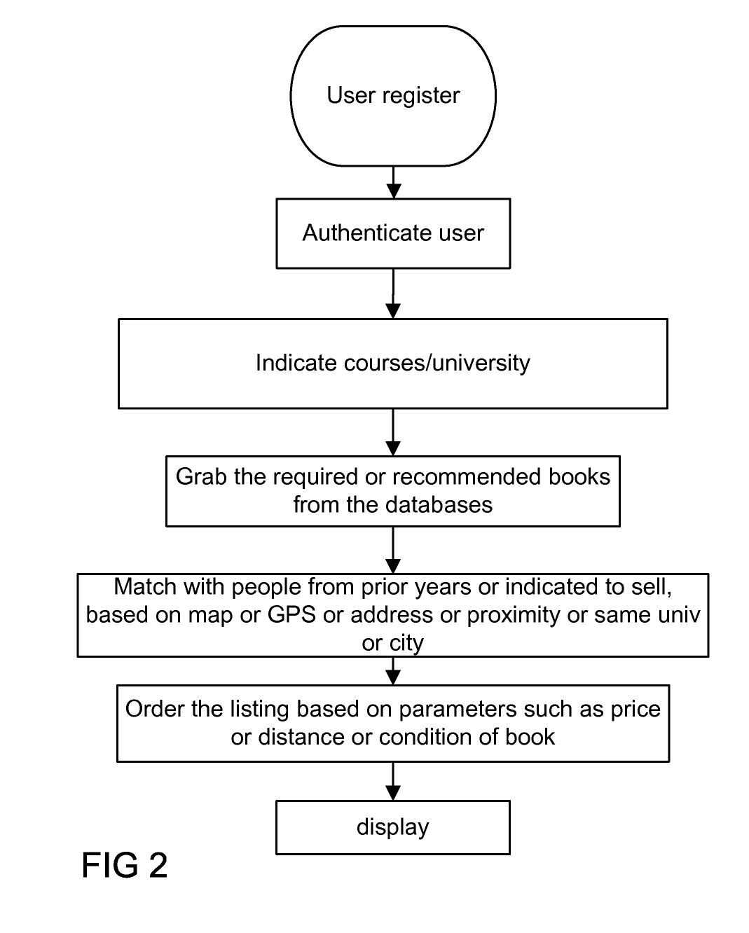

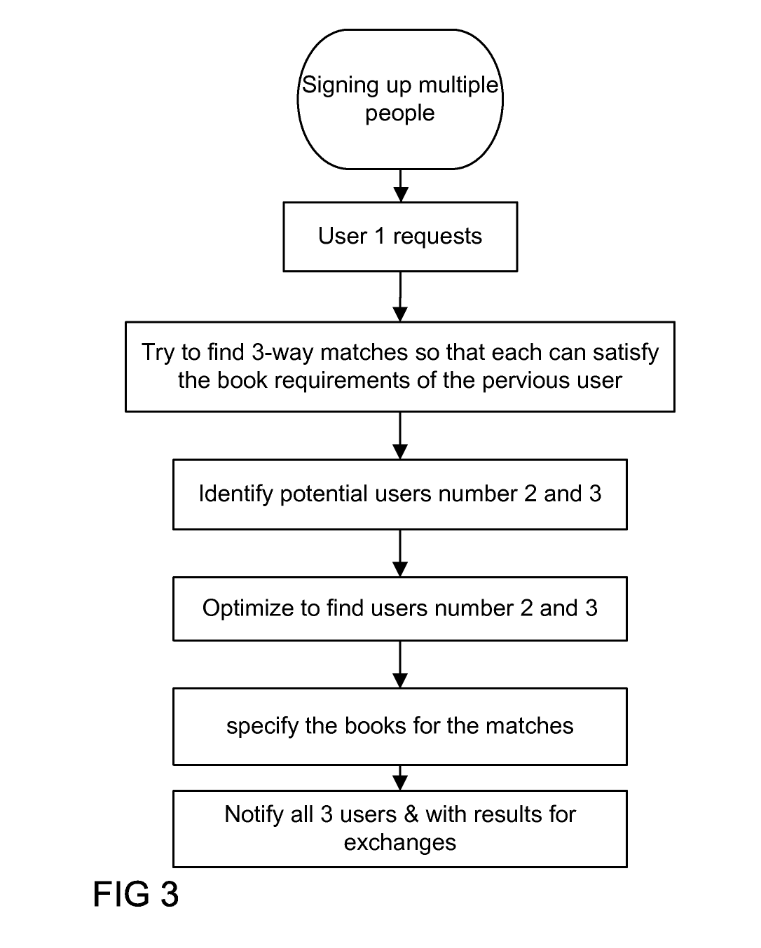

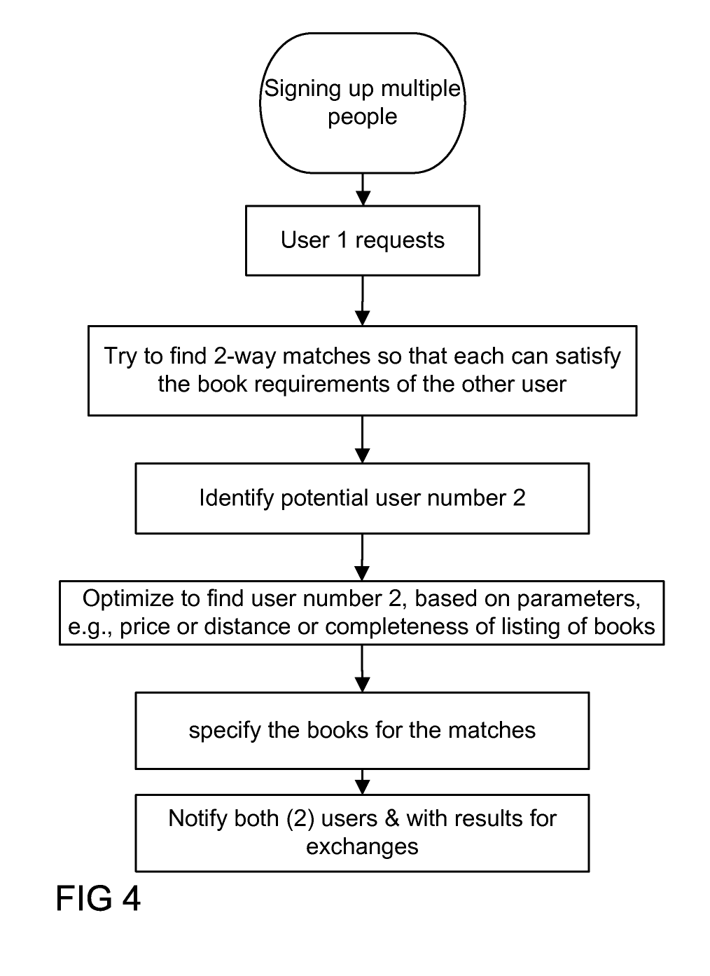

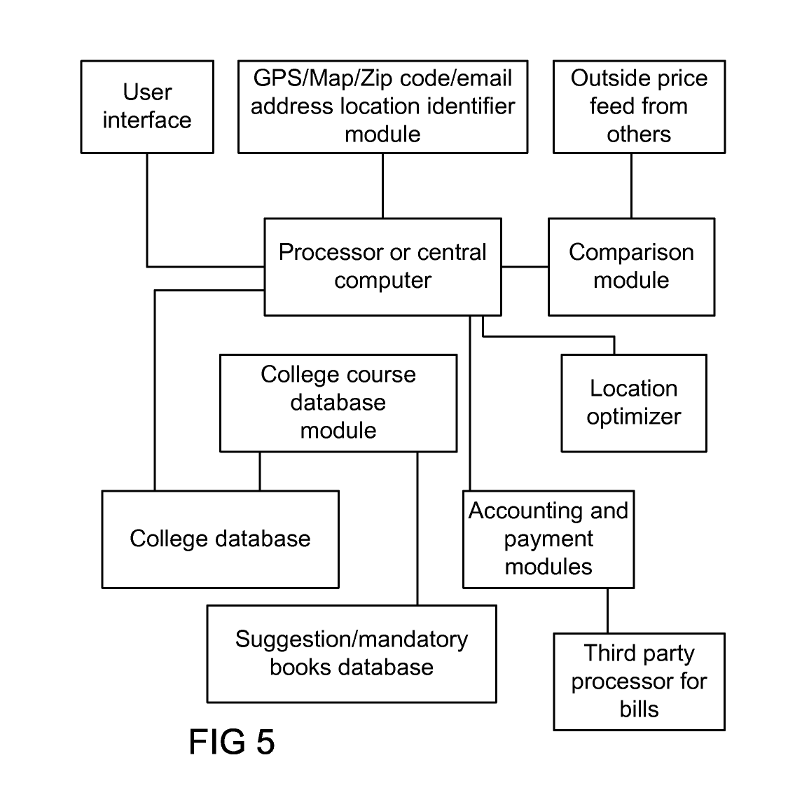

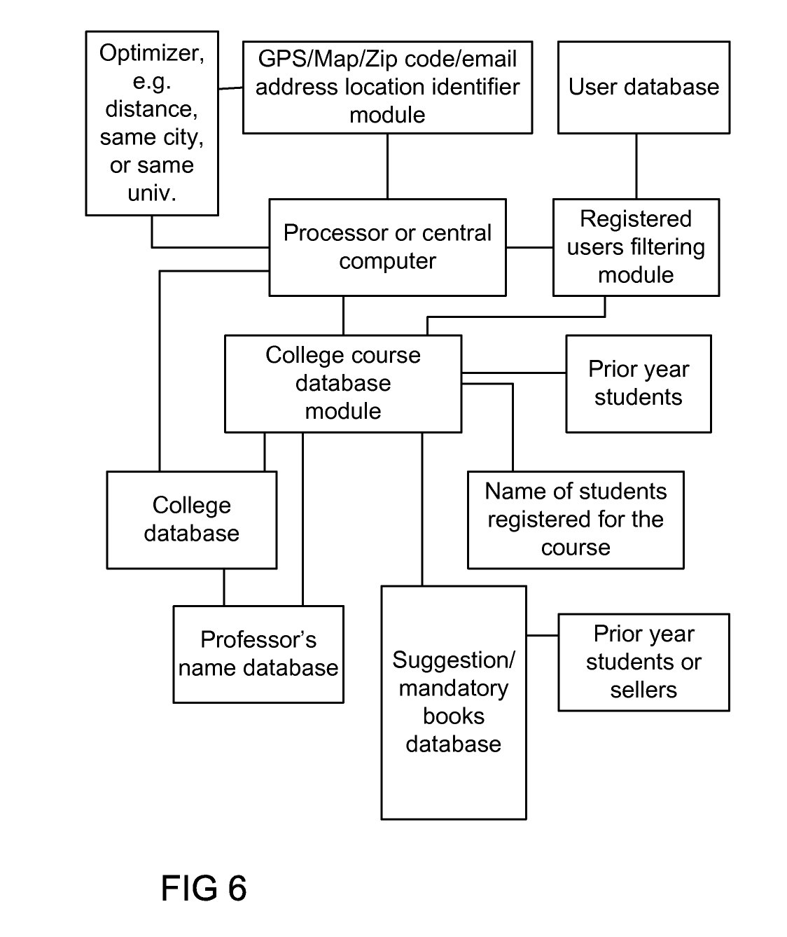

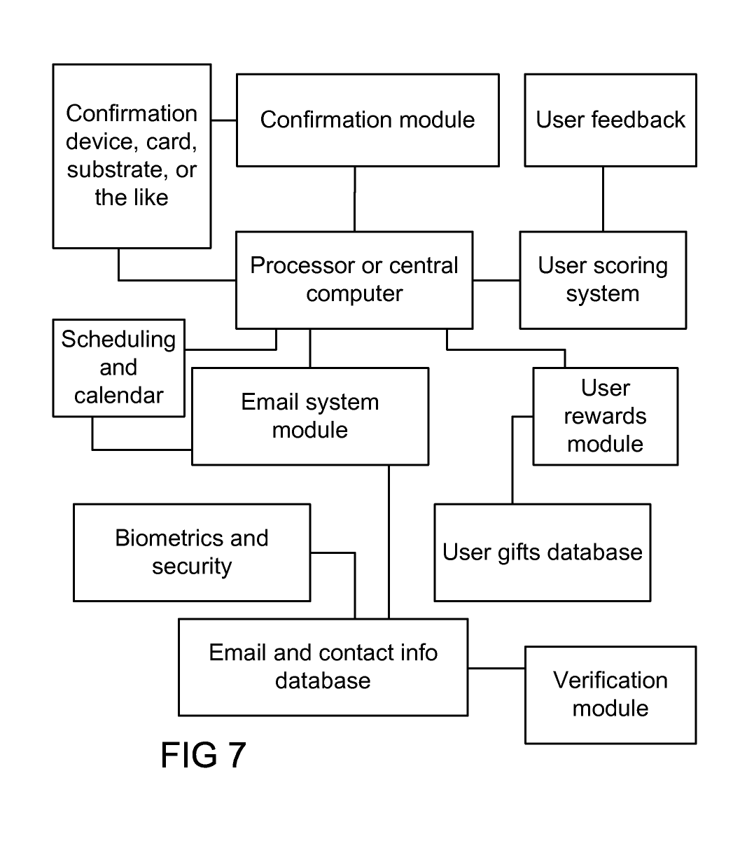

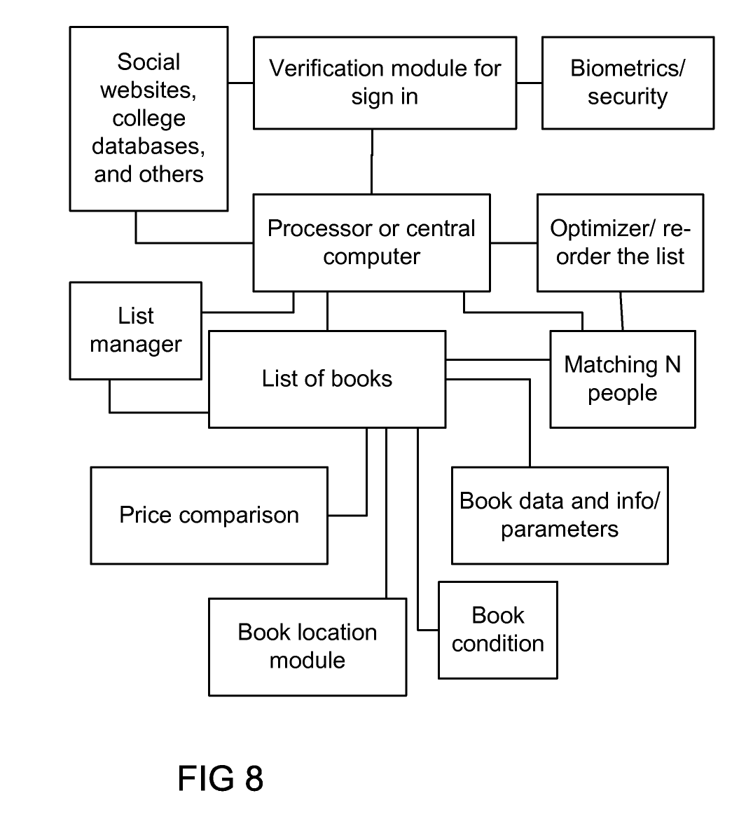

In one embodiment, in FIG. 2, we have user registration, with 3 people matching in FIGS. 3, and 2 people matching in FIG. 4, with college course matching system in FIG. 5, with location matching in FIG. 6, with notification/scheduling and confirmation in FIG. 7, with verification, list management, optimization, and matching in FIG. 8.

In one embodiment, the exchange is done by a carrier, person-to-person, or by our company pre-packaged envelope to other side, with the assumption that the buyer has bought the book already. These are more flexible ways to exchange, if desired, as an option. In one embodiment, we have an in-app capability, e.g., to contact other side to find out the condition of the book, or any other/more information about the book.

In one embodiment, the referral system is based on percentage or based on a fixed value, on next purchase or next session or next book or another prize or accumulated points or gifts or related objects or higher score. In one embodiment, the reliability or credibility score or status helps a user higher status for future transactions, to ensure that the user is reliable for exchange for other users for future.

In one embodiment, the system finds the courses and universities requiring similar books or same books, and match people in databases for registrant for the courses for this and prior semesters or years, automatically, so that they can be notified by email or text or other means such as mail, automatically, to match them together between two sides, for nearby or same college or school, based on map, distance, or GPS, for distance to users or school or both, to order or prioritize the listings, for better display or recommendation automatically to the users, for better matches, or re-order the list, if desired.

In one embodiment, the system finds the courses and universities requiring similar books or same books, and match people in databases for 3-way or N-way matches, such as 3-way triangle matching, so that each person needs the other one's book(s) in a circular or triangle way, to minimize the total trips or mileages for all, or to minimize the total costs for all, as much possible. Thus, the cost functions for one or more users are minimized, or total global costs functions are minimized, for optimum solution, and the result is presented to all 3 users for best value, for their approvals, all at the same time.

In one embodiment, the system is not a middle man. In one embodiment, the system is a middle man. In one embodiment, the system verifies the student being a student through the school directly or registrar or government loan authorities or from prior users or prior users with high creditability score and long history score on this site, with thresholds above S_{c} and Sₕ, respectively. In one embodiment, the system verifies the student by social media sites or Linkedin or Facebook or .edu emails with current dates, to send them the email to claimed email with password and keys for registration to verify the authenticity of the email, or login from reputable social sites, for authenticity.

In one embodiment, the system for the book exchange database comprises: a substrate card with three layers; wherein security images and data are encoded on said three layers; a lens with an adjustable focal length mechanism; wherein said lens is focused on each of said three layers, located horizontally, using said adjustable focal length mechanism; wherein said adjustable focal length mechanism comprises a motor and a rail; wherein said lens is moved using said motor on a vertical rail, up and down; wherein said central computer controls said motor; wherein said central computer adjusts said lens' position on said rail; a randomizer module to generate a random number or seed; wherein said first user's public encryption key, based on public-private keys infrastructure, is encoded randomly on only one of said three layers, using said randomizer module; a biometrics database, holding said first user's biometrics data; wherein said first user's biometrics data, based on said biometrics database, is encoded randomly on only one of said three layers, using said randomizer module; an authentication module; said authentication module verifies security of said book exchange event, by examining said substrate card with said three layers. The randomizer is connected to the system, using a random seed. The horizontal lens is mounted on the vertical rail, going up and down, to focus on each of the 3 layers on the substrate, using the controller or central computer, as the control unit for the motor and location of lens.

In one embodiment, the system has a wand to scan the bar code, or a scanner or detector or camera or smart phone camera, for the book. In one embodiment, the system sorts based on distance, price, credibility score, history-long score, condition of book score, publication date of the book, version of the book, how many times were sold on this site, or the like, for user to see.

In one embodiment, the system uses conventional payment systems, such as Apple Pay, PayPal, credit cards, debit cards, bank loans, bank cards, store cards, credits, refunds, tax returns/refunds, or line of credits, from third party, or from its own internal system/module.

Any variations of the above teaching are also intended to be covered by this patent application.

1. A book exchange database system, said system comprising:
a central computer;
a user interface;
a display;
a location identifier module;
a database for colleges;
a database for courses;
a database for professors;
a database for book prices;
a database for books;
a database for current students;
a database for former students;
a confirmation module;
a notification module;
a scoring module;
a reward module;
a sign-in module;
a security module;
wherein a first user signs in through said sign-in module, using said security module;
wherein said first user is verified by said security module using said first user's email or using a social network login system; wherein said first user is in said database for current students;
wherein said first user specifies a college from said database for colleges through said user interface;
wherein said first user specifies a course from said college from said database for courses, with a link to a professor's name from said database for professors;
wherein said display shows a first book related to said course, from said database for books;
said central computer matches said first book to a first list, using optimization by said location identifier module;
wherein said first user specifies a second user in said database for former students, chosen from said first list;
wherein said first user contacts said second user to set up a location and time for a meet-up or use a courier or mailing system for delivery;
wherein said notification module reminds said location and said time to said first user and said second user by an email or message;
wherein after a book exchange event, said second user gets a confirmation using a card, a code, entering or taking image of license, a phone serial number, a book bar code, fingerprint, or other biometrics, which is evaluated using said confirmation module;
wherein said scoring module re-evaluates score for said first user and said second user, based on said first user and said second user feedback or based on loyalty degree, which is based on number of times of usage;
wherein said reward module increases reward points for said first user and said second user, for referrals.

2. The book exchange database system as recited in claim 1, said system comprises: a substrate card with three layers;
wherein security images and data are encoded on said three layers;
a lens with an adjustable focal length mechanism;
wherein said lens is focused on each of said three layers, using said adjustable focal length mechanism;
wherein said adjustable focal length mechanism comprises a motor and a rail;
wherein said lens is moved using said motor on said rail;
wherein said central computer controls said motor;
wherein said central computer adjusts said lens' position on said rail;
a randomizer module to generate a random number or seed;
wherein said first user's public encryption key, based on public-private keys infrastructure, is encoded randomly on only one of said three layers, using said randomizer module;
a biometrics database, holding said first user's biometrics data;
wherein said first user's biometrics data, based on said biometrics database, is encoded randomly on only one of said three layers, using said randomizer module;
an authentication module;
said authentication module verifies security of said book exchange event, by examining said substrate card with said three layers.

3. The book exchange database system as recited in claim 1, said system comprises: a biometrics module.

4. The book exchange database system as recited in claim 1, said system comprises: a price comparison module.

5. The book exchange database system as recited in claim 1, said system comprises: an optimizer for matching N people, wherein N is an integer equal or more than 2.

6. The book exchange database system as recited in claim 1, said system comprises: a list manager.

7. The book exchange database system as recited in claim 1, said system comprises: a list optimizer.

8. The book exchange database system as recited in claim 1, said system comprises: a book condition module.

9. The book exchange database system as recited in claim 1, said system comprises: a smart card.

10. The book exchange database system as recited in claim 1, said system comprises: a magnetic card.

11. The book exchange database system as recited in claim 1, said system comprises: a chip on a card.

12. The book exchange database system as recited in claim 1, said system comprises: a bill processor module.

13. The book exchange database system as recited in claim 1, said system comprises: a randomizer unit.

14. The book exchange database system as recited in claim 1, said system comprises: an accounting unit.

15. The book exchange database system as recited in claim 1, said system comprises: a school verification unit.

16. The book exchange database system as recited in claim 1, said system comprises: a mail processing unit.

17. The book exchange database system as recited in claim 1, said system comprises: an encryption unit.

18. The book exchange database system as recited in claim 1, said system comprises: a distance optimization unit.

19. The book exchange database system as recited in claim 1, said system comprises: a map unit.

20. The book exchange database system as recited in claim 1, said system comprises: a global positioning service unit.
